(19) United States
(12) Patent Application Publication
(10) Pub. No.: US 2021/0140010 A1
(43) Pub. Date: May 13, 2021

(54) DEVICES, METHODS, AND SYSTEMS FOR COMBINED ORE REDUCTION AND METALS STRIPPING

(71) Applicants: Seth G.P. Babcock, Layton, UT (US); Jonathan P. Boyack, Moore, ID (US); Nathan Davis, Bountiful, UT (US)

(72) Inventors: Seth G.P. Babcock, Layton, UT (US); Jonathan P. Boyack, Moore, ID (US); Nathan Davis, Bountiful, UT (US)

(21) Appl. No.: 16/418,667

(22) Filed: May 21, 2019

(51) Int. Cl. C22B 5/12; C25B 1/04; C25B 1/50

(52) U.S. Cl. CPC C22B 5/12; C25B 1/50; C25B 1/04

(57) ABSTRACT

Devices, systems, and methods for metals production are disclosed. In a first embodiment, a first portion of an ore is reduced, producing metals. A portion of the metals are stripped, complexed, or a combination thereof, into a supercritical carbon dioxide stream.

### CROSS-REFERENCE TO RELATED APPLICATIONS

The present application claims priority to U.S. provisional patent application No. 62/674,157.

### FIELD OF THE INVENTION

The devices, systems, and methods described herein relate generally to ore processing. More particularly, the devices, systems, and methods described herein relate to ore reduction and metals stripping.

### BACKGROUND

Terrestrial ore processing is not often directly translatable to extraterrestrial ore processing. Many known technologies are not viable on earth because of issues such as the toxic nature of the chemicals used, the energy costs of unit operations, and the low abundance of key metals in terrestrial deposits. As these technologies are, generally, poorly suited to terrestrial application, the technologies known are not sufficiently developed for immediate application in extraterrestrial situations. Devices, systems, and methods are needed for better developing these and other technologies to process extraterrestrial ore in a manner that can also be applied terrestrially.

### SUMMARY

Devices, systems, and methods for metals production are disclosed. In a first embodiment, a first portion of an ore is reduced, producing metals. A portion of the metals are stripped, complexed, or a combination thereof, into a supercritical carbon dioxide stream (scCO₂). In a preferred embodiment, the reduction and the scCO₂ treatment occur in the same vessel.

A second embodiment consists of a vessel with a porous plate, a fluid port, and an ore port. An ore is passed through the ore port into the vessel onto the porous plate. A reducing agent is passed through the fluid port. The reducing agent reduces a first portion of the ore, producing metals. Resultant fluids are removed from the vessel through the fluid port. A supercritical carbon dioxide stream is passed through the fluid port into the vessel. The supercritical carbon dioxide stream strips, complexes, or a combination thereof, a portion of the metals.

In a third embodiment, a first portion of an ore is reduced, producing metals. A portion of the metals is amalgamated with a mercury stream. The metals and the mercury stream are separated. In some embodiments, separating involves boiling off the mercury by reduced pressure, heat, or a combination thereof.

The ore may include an oxide ore, a sulfide ore, a sulfate ore, a silicate ore, a carbonate ore, a phosphate ore, or a combination thereof.

Reducing the ore may include passing a reducing agent across the ore. The reducing agent may be hydrogen, hydrogen plasma, carbon monoxide, an alkaline metal, an alkaline earth metal, or a combination thereof.

Reducing the ore may produce a water stream from the oxide ore and silicate ore and a hydrogen sulfide stream from the sulfide ore. The water stream may be electrolyzed, producing hydrogen and oxygen.

The vessel may have a porous plate onto which the ore is passed. The vessel may have a microwave emitter that induces the hydrogen plasma.

The supercritical carbon dioxide stream may have reagents in solution that complex the metals, unreduced metals from a second portion of the ore, or a combination thereof. The reagents may include organic amines, organic acids, ketones, diketones, ethers, alcohols, dithiocarbamates, organophosporous reagents, macrocyclic compounds, halogenated organic amines, halogenated organic acids, halogenated ketones, halogenated diketones, halogenated ethers, halogenated alcohols, halogenated dithiocarbamates, halogenated organophosporous reagents, cyanide compounds, or a combination thereof.

### BRIEF DESCRIPTION OF THE DRAWINGS

In order that the advantages of the described devices, systems, and methods will be readily understood, a more particular description of the devices, systems, and methods briefly described above will be rendered by reference to specific embodiments illustrated in the appended drawings. Understanding that these drawings depict only typical embodiments of the described devices, systems, and methods and are not therefore to be considered limiting of its scope, the devices, systems, and methods will be described and explained with additional specificity and detail through use of the accompanying drawings, in which:

FIG. 1 is an isometric cutaway view of a vessel for metals production.

FIG. 2 is a process flow diagram for metals production.

FIG. 3 is a process flow diagram for metals production.

FIG. 4 shows a method for metals production.

FIG. 5 shows a method for metals production.

### DETAILED DESCRIPTION

The following description recites various aspects and embodiments of the inventions disclosed herein. No particular embodiment is intended to define the scope of the invention. Rather, the embodiments provide non-limiting examples of various compositions, and methods that are included within the scope of the claimed inventions. The description is to be read from the perspective of one of ordinary skill in the art. Therefore, information that is well known to the ordinarily skilled artisan is not necessarily included.

The following terms and phrases have the meanings indicated below, unless otherwise provided herein. This disclosure may employ other terms and phrases not expressly defined herein. Such other terms and phrases shall have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

Reduction of ores using reducing agents, such as hydrogen or hydrogen plasma, is a process that has been studied at the laboratory scale but which has not been applied to large scale mining application, as far as the Applicants have been able to determine. Supercritical carbon dioxide is used to strip heavy metals from soil and has been studied by the Bureau of Mines and others for rare earth metal stripping, but no installations in large scale processing facilities exist, as far as the Applicants have been able to determine. The combination of these two technologies, either in sequence or in the same vessel, is disclosed herein. Individually, each process requires solids handling. By eliminating solids handling, the combined processes become simpler, more energy efficient, and more productive than they are separately. In conjunction with the devices disclosed herein, the process can even be used effectively in low gravity or microgravity.

Referring now to the figures, FIG. 1 is an isometric cutaway view 100 of a vessel for metals production that may be used in the described devices, methods, and systems herein. A vessel 102 includes a bottom porous plate 104, a top porous plate 106, an ore port 108, a first fluid port 110, a second fluid port 112, and a third fluid port 114. The fluid ports 110, 112, and 114 have valves (not shown) controlling fluid flow into or out of the vessel 102. The ore port 108 is a flange that, when opened, allows ore to be placed onto the bottom porous plate 104. The ore port 108 is then closed.

In a first embodiment, a reducing agent is passed through the first fluid port 110. The reducing agent reduces a first portion of the ore, producing metals. Any unused reducing agent and any fluids produced during reduction are pulled out of the vessel 102 through the second fluid port 112 by vacuum. A supercritical carbon dioxide stream (scCO₂) is then passed through the first fluid port 110 into the vessel. Once the vessel 102 is up to pressure that keeps the carbon dioxide in the supercritical phase, the scCO₂ strips, complexes, or both strips and complexes a portion of the metals, and optionally a portion of the unreduced metals, in the vessel 102 in a batch. Once a time period has passed, the scCO₂, now containing metals, is passed out of the second fluid port 112 and sent for further processing. The ore port 108 is then opened and the leftover solids are removed in preparation for the next batch.

In a second embodiment, after pressurizing the vessel 102 with the scCO₂, the valve on the fluid port 112 is opened and scCO₂ with a reducing agent added are passed together into vessel 102 through fluid inlet 110. The reducing agent reduces a first portion of the ore, producing metals. Concurrently, the scCO₂ strips, complexes, or both strips and complexes a portion of the metals, and optionally a portion of the unreduced metals, in the vessel 102 in a semi-batch manner, until the ore is sufficiently stripped of metals. At that point the remainder of the fluids are removed, the ore port 108 is opened, and the leftover solids are removed in preparation for the next batch of ore.

In either embodiment, a complexing agent may be added to aid in complexing the metals or unreduced metals.

Referring now to FIG. 2, FIG. 2 is a process flow diagram for metals production that may be used in the described devices, methods, and systems herein. Ore feed stream 260 is passed through ore port 214 into vessel 202, settling on porous plate 208. Reducing agent 264, in this embodiment, hydrogen gas, is passed from hydrogen tank 236 through valve 234 and into vessel 202 through fluid port 210. Reducing agent 264 is turned into a hydrogen plasma by microwave radiation induced by microwave emitter 204. The hydrogen plasma reduces a portion of the ore feed stream 260 into metals, leaving spent ore stream 262 with water as a side product. The water and any unreacted hydrogen gas are pulled out of vessel 102 through fluid port 212 and valve 216 as stream 272. Stream 272 is cooled across exchanger 218, producing mixed water stream 270, which passes through valve 222 and into electrolysis unit 238. Electrolysis produces hydrogen and oxygen from the water in mixed water stream 270. Any hydrogen from mixed water stream 270 combines with the hydrogen produced to make hydrogen product stream 268, which is sent to hydrogen tank 236.

Supercritical carbon dioxide (scCO₂) stream 266 is passed through valve 232 and fluid port 210 into vessel 202. The scCO₂ stream 266 strips, complexes, or strips and complexes a portion of the metals, and optionally, a portion of the unreduced metals, into solution. In some embodiments, this is assisted by the use of reagents. The pregnant scCO₂ stream 273 is passed out valve 216, and through heat exchanger 218, which heats pregnant scCO₂ stream 273 to form separator feed stream 274. Separator feed stream 274 passes through valve 220 and into separator 224, where the metals 282 are separated from the carbon dioxide 276. The carbon dioxide is compressed and cooled through compressor 226 and heat exchanger 228, respectively, to produce a scCO₂ feed stream 278, which is passed to scCO₂ tank 230. The spent ore stream 262 is then removed from the vessel 202.

In microgravity environments, ore feed stream 260 floats between porous plate 206 and porous plate 208.

In some embodiments, vessel 202 includes a heater.

Referring now to FIG. 3, FIG. 3 is a process flow diagram for metals production that may be used in the described devices, methods, and systems herein. Raw ore feed stream 350 is passed into comminution unit 354. In this embodiment, the raw ore is crushed in a gyratory crusher. The crushed ore exits the crusher in crushed ore stream 352. The crushed ore stream is passed into separation unit 355. In this embodiment, the separation unit is a gravity separator. The separated oxide ore leaves the separation unit and becomes ore feed stream 360. Ore feed stream 360 is passed through ore port 314 into vessel 302, settling on porous plate 308. Reducing agent 364, in this embodiment, hydrogen gas, is passed from hydrogen tank 336 through valve 334 and into vessel 302 through fluid port 310. Reducing agent 364 is turned into a hydrogen plasma by microwave radiation induced by microwave emitter 304. Microwave emitter 304 also includes a heater for heating vessel 302. The hydrogen plasma reduces a portion of the ore feed stream 360 into metals, with water as a side product. The water and any unreacted hydrogen gas are pulled out of vessel 102 through fluid port 312 and valve 316 as stream 372. Stream 372 is cooled across exchanger 318, producing mixed water stream 370, which passes through valve 322 and into electrolysis unit 338. Electrolysis produces hydrogen and oxygen from the water in mixed water stream 370. Any hydrogen from mixed water stream 370 combines with the hydrogen produced to make hydrogen product stream 368, which is sent to hydrogen tank 336.

A mercury stream 366 is passed through valve 332 and fluid port 310 into vessel 302. The mercury stream 366 amalgamates with a portion of the metals. The amalgam 373 is passed out valve 316, and through heat exchanger 318, which heats amalgam 373 to form separator feed stream 374. Separator feed stream 374 passes through valve 320 and into separator 324, where the metals 382 are separated from the mercury 376. The mercury 376 is returned to mercury tank 330. The metals are further purified, in this embodiment, in a smelter (not shown). The spent ore stream 362 is then removed from the vessel 302.

In some embodiments, separating the metals from them mercury consists of boiling off the mercury by reduced pressure, heat, or a combination thereof.

Referring now to FIG. 4, FIG. 4 shows a method 400 for metals production that may be used with the described devices, systems, and methods herein. At 401, a first portion of an ore is reduced, producing metals. At 402, a portion of the metals is stripped, complexed, or a combination thereof, into a supercritical carbon dioxide stream.

Referring now to FIG. 5, FIG. 5 shows a method 400 for metals production that may be used with the described devices, systems, and methods herein. At 501, a vessel is provided. At 502, an ore is passed into the vessel. At 503, a reducing agent is passed into the vessel. At 504, a portion of the ore is reacted with the reducing agent to produce one or more reduced metals. At 505, the vessel is evacuated of the resultant fluids. At 506, the vessel is pressurized with supercritical carbon dioxide. At 507, a portion of the one or more reduced metals is stripped, complexed, or a combination thereof into the supercritical carbon dioxide, resulting in a product fluid. At 508, the product fluid is passed out of the vessel.

In some embodiments, the ore may include oxide ores, sulfide ores, sulfate ores, silicate ores, carbonate ores, phosphate ores, or a combination thereof.

In some embodiments, the reducing agent may include hydrogen, hydrogen plasma, carbon monoxide, an alkaline metal, an alkaline earth metal, or a combination thereof.

In some embodiments, the ore produces a water stream from oxide ores and silicate ores and a hydrogen sulfide stream from sulfide ores.

In some embodiments, the supercritical carbon dioxide stream comprises reagents in solution that complex the metals, unreduced metals from a second portion of the ore, or a combination thereof. These reagents may include organic amines, organic acids, ketones, diketones, ethers, alcohols, dithiocarbamates, organophosporous reagents, macrocyclic compounds, halogenated organic amines, halogenated organic acids, halogenated ketones, halogenated diketones, halogenated ethers, halogenated alcohols, halogenated dithiocarbamates, halogenated organophosporous reagents, cyanide compounds, or a combination thereof.

In some embodiments, the metals are purified by smelting, refining, or a combination thereof. In some embodiments, the ore is comminuted before passing the ore to the reactor. Comminuting may include passing the oxide ore through sag mills, ball mills, cone crushers, roll crushers, impact crushers, hammer mills, jaw crushers, gyratory crushers, rotary breakers, other comminution devices known to those of normal skill in the art, or a combination thereof.

In some embodiments, separating includes gravity separation, vibration separation, flotation separation, magnetic separation, or a combination thereof.

In some embodiments, reducing occurs simultaneously with stripping, complexing, or a combination thereof, in the same vessel.

In some embodiments, the oxygen produced by electrolysis may be stored for fuel or air. Metals may be fed into a 3D Printer and replacement parts printed as needed. A 3D printer can be used to fuse alumina powder into castings for use in parts making. Metals may then be poured into the castings to make a variety of parts.

Fluids may be used for forced ore and product flow (slurries) in low/micro gravity environments.

Rocket fuel may be produced from the products of this process. Powdered aluminum and oxygen can be used as a rocket fuel. Once aluminum is separated from other metals produced in this process and is ground into a fine powder (by other parts made from other metals produced by this process) it may be loaded into rockets for transport into lunar orbit. A lunar fuel depot may be created thereby to allow for cheaper travel to Mars and the outer solar system.

Hydrogen is the preferred reducing agent as it is easily recyclable through electrolysis. The disadvantage of this is that electrolysis is an energy intensive process. This tradeoff is justified as the cost to transport regular shipments of reducing agent is orders of magnitude greater than the one-time cost of sending up greater power production capability in the form of solar panels and batteries or even small, modular, nuclear reactors.

This process may help pave the way for greater colonization of the moon. One of the issues of building the first moon colonies will be sourcing building materials. The devices, systems, and methods detailed in this patent could be used to produce some of the structural materials needed to build a viable base on the moon. The first colonies will likely be built underground, but structural material will be needed for walls, flooring, and reinforcement.

1. A method for metals production comprising:
reducing a first portion of an ore, producing metals in a vessel; and
stripping, complexing, or a combination thereof, a portion of the metals into a supercritical carbon dioxide stream in the vessel.

2. The method of claim 1, wherein the ore comprises an oxide ore, a sulfide ore, a sulfate ore, a silicate ore, a carbonate ore, a phosphate ore, or a combination thereof.

3. The method of claim 1, wherein reducing an ore comprises passing a reducing agent across the ore.

4. The method of claim 3, wherein the reducing agent comprises hydrogen, hydrogen plasma, carbon monoxide, an alkaline metal, an alkaline earth metal, or a combination thereof.

5. The method of claim 4, wherein reducing the ore produces a water stream from the oxide ore and silicate ore and a hydrogen sulfide stream from the sulfide ore.

6. The method of claim 5, further comprising electrolyzing the water stream, producing hydrogen and oxygen.

7. The method of claim 1, wherein the vessel further comprises a porous plate onto which the ore is passed.

8. The method of claim 1, wherein the vessel further comprises a microwave emitter that induces the hydrogen plasma.

9. The method of claim 1, wherein the supercritical carbon dioxide stream comprises reagents in solution that complex the metals, unreduced metals from a second portion of the ore, or a combination thereof.

10. The method of claim 9, wherein the reagents comprise organic amines, organic acids, ketones, diketones, ethers, alcohols, dithiocarbamates, organophosporous reagents, macrocyclic compounds, halogenated organic amines, halogenated organic acids, halogenated ketones, halogenated diketones, halogenated ethers, halogenated alcohols, halogenated dithiocarbamates, halogenated organophosporous reagents, cyanide compounds, or a combination thereof.

11. The method of claim 1, further comprising separating the supercritical carbon dioxide stream and the portion of the metals by evaporating off the supercritical carbon dioxide stream.

12. The method of claim 11, further comprising purifying the portion of the metals.

13. The method of claim 12, wherein the purifying step comprises smelting, refining, or a combination thereof.

14. The method of claim, further comprising comminuting the ore before the reactor, wherein comminuting comprises passing the oxide ore through sag mills, ball mills, cone crushers, roll crushers, impact crushers, hammer mills, jaw crushers, gyratory crushers, rotary breakers, or a combination thereof.

15. The method of claim 14, further comprising separating the oxide ore from contaminants before passing the oxide ore to the reactor.

16. The method of claim 15, wherein separating comprises gravity separation, vibration separation, flotation separation, magnetic separation, or a combination thereof.

17. The method of claim 1, wherein reducing and stripping, complexing, or a combination thereof, occur simultaneously in the same vessel.

18. A method for ore processing comprising:
providing a vessel;
passing an ore into the vessel;
passing a reducing agent into the vessel;
reacting at least a portion of the ore with the reducing agent to produce one or more reduced metals;
evacuating the vessel of resultant fluids;
pressurizing the vessel with supercritical carbon dioxide;
stripping, complexing, or a combination thereof at least a portion of the one or more reduced metals into the supercritical carbon dioxide, resulting in a product fluid; and
passing the product fluid out of the vessel.

19. A device for metals production comprising:
a vessel comprising a porous plate, one or more fluid ports, and an ore port;
wherein:
an ore is passed through the ore port into the vessel onto the porous plate;
a reducing agent is passed through the one or more fluid ports;
the reducing agent reduces a first portion of the ore, producing metals;
fluids are removed from the vessel through the one or more fluid ports; and
a supercritical carbon dioxide stream is passed through the fluid port into the vessel;
the supercritical carbon dioxide stream strips, complexes, or a combination thereof, a portion of the metals.

20. The device of claim 19, wherein the reducing agent comprises hydrogen gas.
